(19) United States
(12) Patent Application Publication
(10) Pub. No.: US 2009/0293619 A1
(43) Pub. Date: Dec. 3, 2009

(54) METHOD AND APPARATUS FOR EVALUATING ADHESION STRENGTH OF A THIN FILM

(75) Inventors: Mutsuo Yoshinami, Kawasaki (JP); WooSuk Song, Kawasaki (JP); Yoshinori Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/352,317

(22) Filed: Jan. 12, 2009

(30) Foreign Application Priority Data
May 30, 2008 (JP) 2008-142504

(51) Int. Cl. G01N 29/04

(52) U.S. Cl. 73/588

(57) ABSTRACT

A method and apparatus for evaluating the adhesion strength of a thin film are capable of quantitatively and qualitatively evaluating the adhesion strength of thin films that were difficult to evaluate with conventional methods. The method of evaluating the adhesion strength of a thin film includes: a step of placing an ultrasonic vibration needle in contact with one of an edge portion in a planar direction of a thin film formed on a substrate and a periphery of the edge portion, and applying ultrasonic vibration; a step of detecting occurrences of detachment at the edge portion of the thin film after application of the ultrasonic vibration; and a step of evaluating the adhesion strength of the thin film on the substrate according to the occurrences of detachment.

### BACKGROUND OF THE INVENTION

1. Field of the Invention

The present invention relates to a method and apparatus for evaluating the adhesion strength of a thin film, and in more detail to a method and apparatus for evaluating the adhesion strength of a thin film by applying ultrasonic vibration to a thin film formed on a substrate and detecting detachment of the thin film.

2. Related Art

One method of evaluating the adhesion strength of a thin film formed on a substrate (such as a circuit board) by plating, sputtering, or vacuum deposition is called “peel-off testing”. Peel-off testing methods include (1) a tape-based method (shown in FIG. 11) and (2) a solder-based method (shown in FIG. 12) (see “Methods of Evaluating Adhesion of Plated Layers” in JIS/H8504). Aside from such methods, it is also possible to carry out (3) a scraping test method that uses a contact needle (see FIG. 13).

A summary of the methods mentioned above and their respective problems are given below.

With method (1), adhesive tape 103 is stuck onto the surface of a thin film 102 formed on a substrate 101 and is then peeled off in the direction of the arrow to evaluate the adhesion strength of the thin film 102. The adhesive force of the adhesive tape is comparatively low at around 3 to 5 N per 10 mm of width, which makes this method unsuited to evaluating thin films with a greater adhesive force. In addition, the adhesive compound of the adhesive tape is sometimes left on the thin film of the evaluated object as residue. As a further problem, static electricity is produced when the adhesive tape is peeled off, which can cause damage depending on the thin film of the evaluated object.

With method (2), an L-shaped bracket 203 is fixed by soldering to a plated film 202 formed on the surface of a substrate 201 and the L-shaped bracket 203 is then pulled in the direction of the arrow using a holder 204 to test the adhesion strength of the plated film 202. With this method, since the soldered part is heated to 200° C. or above, there are cases where the thin film (i.e., the plated layer) itself is thermally changed, which can result in a change in the adhesion strength. It is also not possible to test actual products, and test patterns that are fabricated separately to products become necessary.

The methods (1) and (2) have a further problem in that the adhesive force of the adhesive tape and the adhesive force of the solder can only be qualitatively evaluated as a reference.

With method (3), a contact needle 303 that is connected to a weight applying apparatus 305 is used to scrape a thin film 302 on the surface of a test piece 301 fixed onto a sample stage 304 and the adhesion strength of the thin film 302 is evaluated by observing detachment of the film. With this method, a soft thin film composed of Au (gold) for example will be greatly deformed by the contact needle, and in many cases the film will be scratched away before detachment occurs, which means that the adhesion strength cannot be properly evaluated.

In addition, the methods (1) to (3) are thin film evaluating methods that test a certain area and are therefore not suited to evaluating thin films that are formed in patterns that are several tens of microns (μm) in size.

In response to such situation, the method disclosed in Patent Document 1 has been proposed as a method of measuring the adhesion strength of a thin film. According to such method, the adhesion strength is measured by etching a fine pattern of islands in a thin film to be measured, carrying out ultrasonic washing, and then checking the number of missing parts in the island pattern.

### Patent Document 1

Japanese Laid-Open Patent Publication No. S62-49239

### SUMMARY OF THE INVENTION

The present invention has an object of providing a method and apparatus for evaluating the adhesion strength of a thin film that can qualitatively and quantitatively evaluate the adhesion strength of thin films that were difficult to evaluate with conventional methods.

To solve the stated problem, a method of evaluating the adhesion strength of a thin film according to the present invention includes: a step of placing an ultrasonic vibration needle in contact with one of an edge portion in a planar direction of a thin film formed on a substrate and a periphery of the edge portion, and applying ultrasonic vibration; a step of detecting occurrences of detachment at the edge portion of the thin film after application of the ultrasonic vibration; and a step of evaluating the adhesion strength of the thin film on the substrate according to the occurrences of detachment.

In this way, by applying ultrasonic vibration to the edge portion of the thin film and detecting detachment that can occur at the edge portion, it is possible to evaluate the adhesion strength of the thin film.

The step of applying the ultrasonic vibration may interpose a vibration transmitting member, which is capable of line or surface contact on one of the edge portion of the thin film and the periphery thereof, between the one of the edge portion and the periphery thereof and the ultrasonic vibration needle.

In this way, when it is difficult for the ultrasonic vibration needle to contact the edge portion, such as when the thin film is small or thin, or when the thin film is formed of a soft material is being tested, by interposing the vibration transmitting member that is capable of line or surface contact, it is possible to apply ultrasonic vibration to the thin film.

The step of detecting the occurrences of detachment may connect resistance measuring terminals to both ends in a length direction of the thin film that has been formed as a wire of a predetermined width, measure an electrical resistance of the thin film before and after the step of applying the ultrasonic vibration, and detect the occurrences of detachment by comparing resistance values obtained before and after the step of applying the ultrasonic vibration.

By measuring the electrical resistance of a thin film that is to be measured before and after the application of ultrasonic vibration and comparing the obtained resistance values in this way, it is possible to detect occurrences of detachment, which is effective especially in cases where it is difficult to visually detect detachment of the thin film.

The thin film may have a thickness of several microns to several tens of microns in a direction perpendicular to a surface thereof.

Since it was difficult to evaluate the adhesion strength of a thin film with a thickness of several microns to around several tens of microns using conventional methods, the present method of evaluating is especially effective in making it possible to evaluate the adhesion strength of such thin film.

The method of evaluating the adhesion strength of a thin film may further include, after the step of applying the ultrasonic vibration and before the step of detecting the occurrences of detachment, a step of carrying out a process to accelerate detachment.

By adding the step of carrying out a process to accelerate detachment, it is possible to make parts of the thin film where the adhesion strength is insufficient more prominent, and thereby facilitate the determination.

The method of evaluating the adhesion strength of a thin film according to the present invention may form an evaluation thin film of a same material and a same thickness as a product thin film, which is formed on a substrate and is to be used as a product, on the same substrate by a same step as the product thin film, and may then evaluate the adhesion strength of the product thin film by carrying out the method of evaluating the adhesion strength of a thin film described above on the evaluation thin film.

In this way, by evaluating the adhesion strength of an evaluation thin film that is separately formed of the same material and the same thickness on the same substrate by the same step as a product thin film, it is possible to evaluate the adhesion strength of the product thin film that is the object for which measurement is actually desired.

An evaluating apparatus for evaluating the adhesion strength of a thin film according to the present invention includes: a stage onto which is fixed a substrate that has a thin film formed on an upper surface thereof; ultrasonic vibration applying means for applying ultrasonic vibration to one of an edge portion in a planar direction of the thin film and a periphery of the edge portion, the ultrasonic vibration applying means including an ultrasonic vibrator and an ultrasonic vibration needle; and detachment detecting means for detecting occurrences of detachment at the edge portion of the thin film, wherein the detachment detecting means includes at least one of means for obtaining an image of the edge portion of the thin film and means for measuring electrical resistance of the thin film.

In this way, it is possible to construct an evaluating apparatus for the adhesion strength of a thin film as a series of systems. It is also possible to automate the evaluation steps, which was difficult with conventional technology.

According to the present invention, it is possible to evaluate the adhesion strength of a thin film formed in a pattern that was difficult to evaluate using conventional methods.

### BRIEF DESCRIPTION OF THE DRAWINGS

FIG. 1 is a diagram useful in explaining a method of evaluating the adhesion strength of a thin film according to a first embodiment of the present invention;

FIG. 2 is a schematic diagram showing an example of the construction of an evaluating apparatus for evaluating the adhesion strength of a thin film according to embodiments of the present invention;

FIG. 3 is a schematic diagram showing an example of a process that can detect the occurrence of detachment of a thin film;

FIGS. 4A and 4B are diagrams useful in explaining a method of evaluating the adhesion strength of a thin film according to a second embodiment of the present invention;

FIG. 5 is a diagram useful in explaining a method of evaluating the adhesion strength of a thin film according to a third embodiment of the present invention;

FIGS. 6A and 6B are schematic diagrams showing first specific examples of evaluation thin films;

FIGS. 7A and 7B are schematic diagrams showing second specific examples of evaluation thin films;

FIG. 8 is a schematic diagram showing a third specific example of an evaluation thin film;

FIG. 9 is a graph of data showing examples of evaluation according to a method of evaluating the adhesion strength of a thin film according to an embodiment of the present invention;

FIG. 10 is a micrograph showing an example where detachment has occurred for a thin film;

FIG. 11 is a schematic diagram showing an example of an apparatus for implementing a conventional method of evaluating the adhesion strength of a thin film;

FIG. 12 is a schematic diagram showing another example of an apparatus for implementing a conventional method of evaluating the adhesion strength of a thin film; and

FIG. 13 is a schematic diagram showing yet another example of an apparatus for implementing a conventional method of evaluating the adhesion strength of a thin film.

### DESCRIPTION OF THE PREFERRED EMBODIMENTS

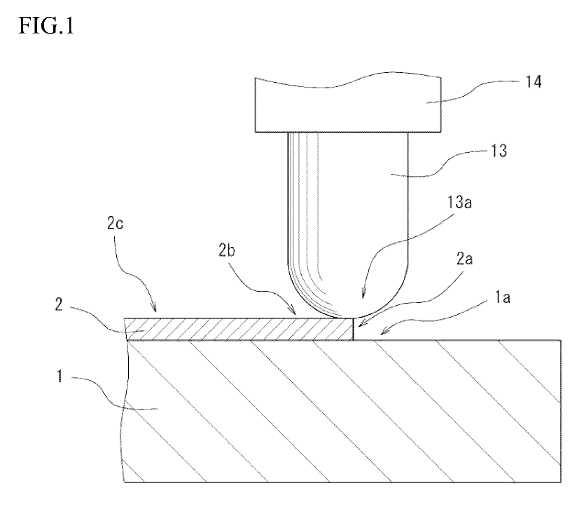

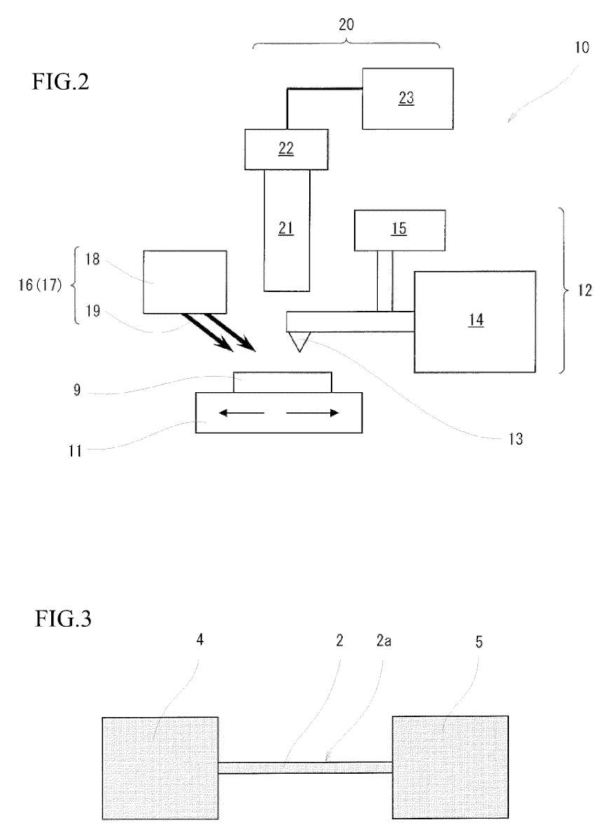

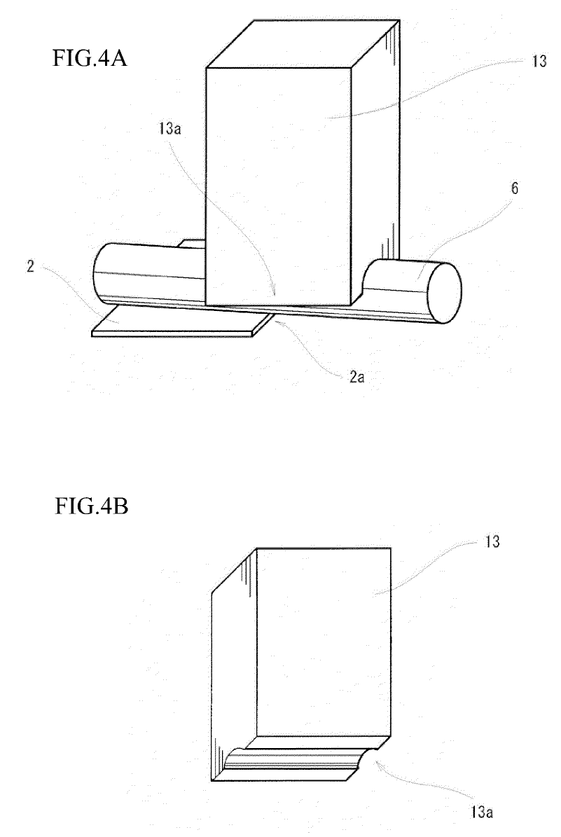

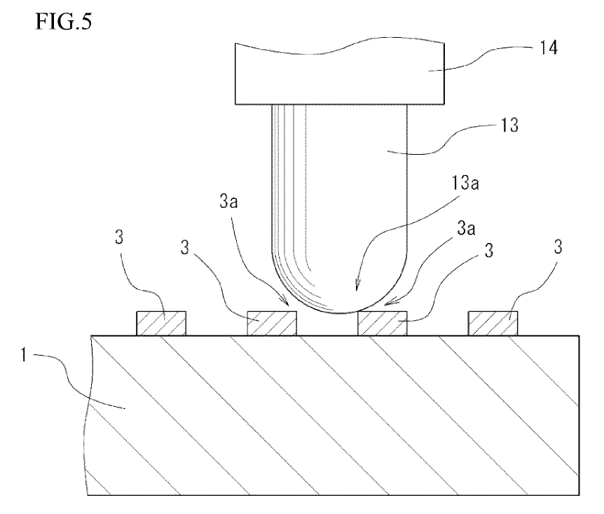

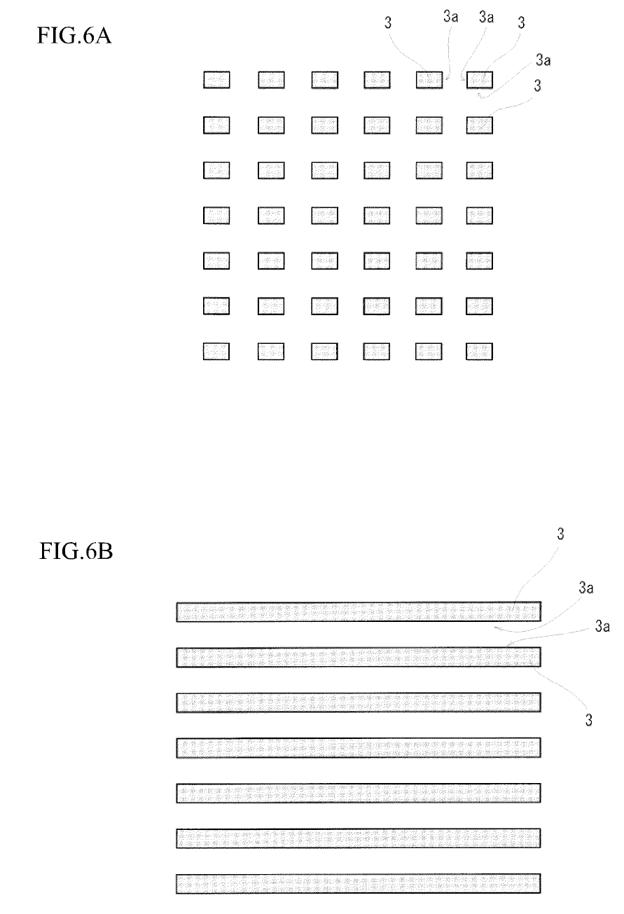

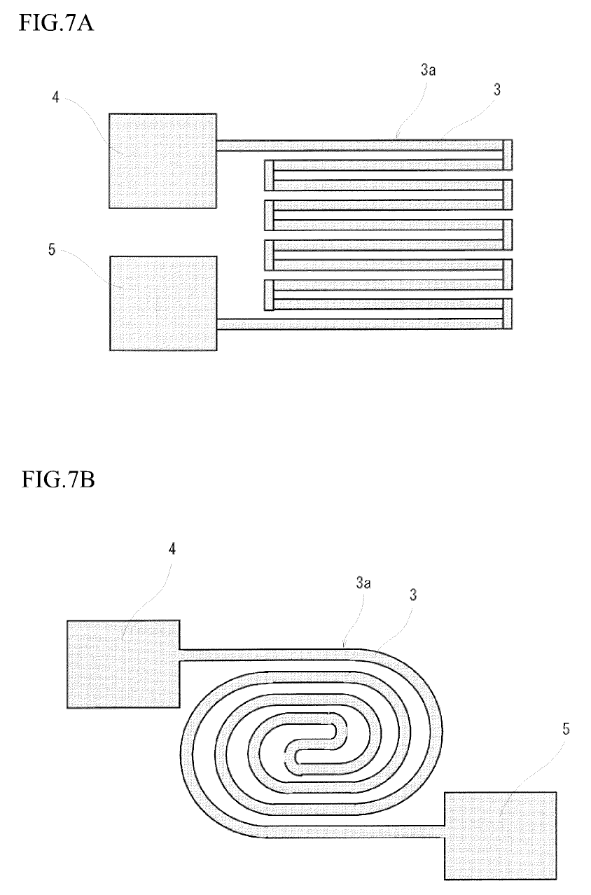

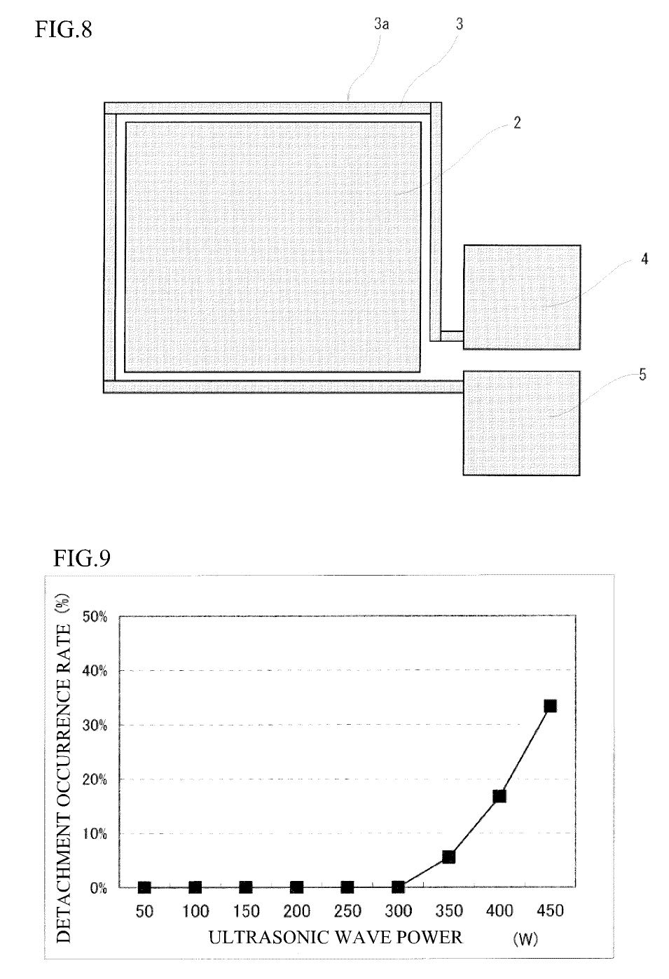

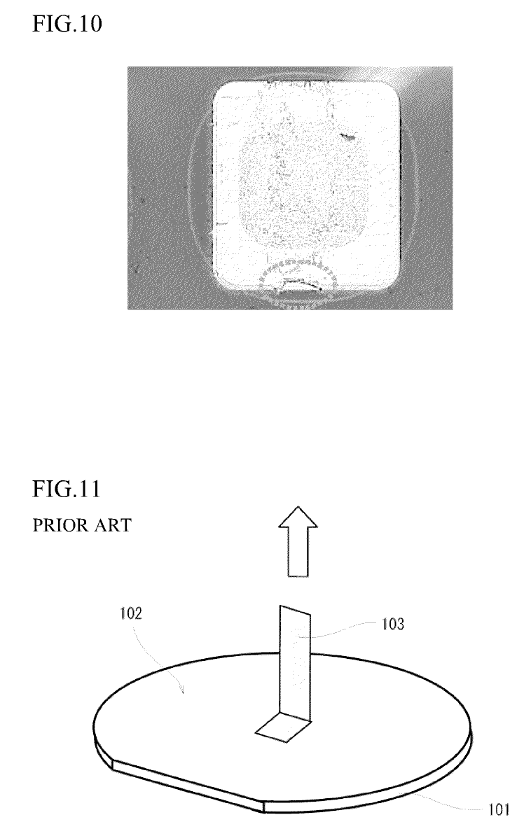

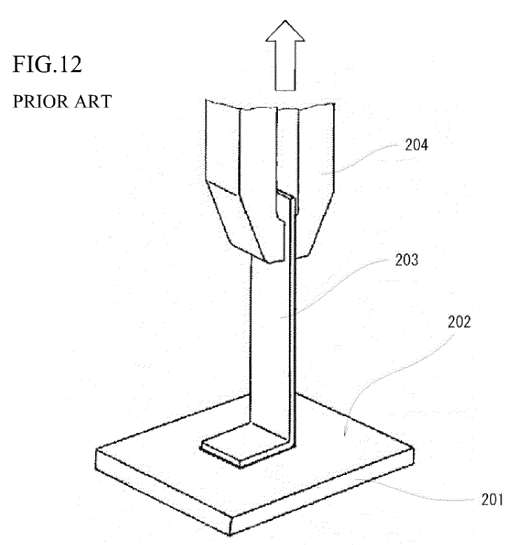

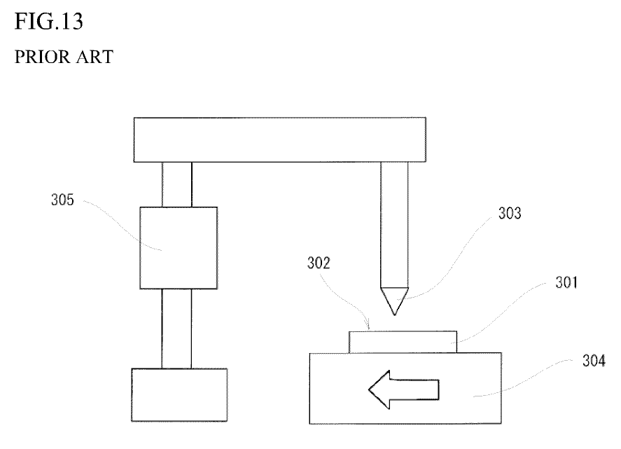

Preferred embodiments of the present invention will now be described in detail with reference to the drawings. FIG. 1 is a diagram useful in explaining a method of evaluating the adhesion strength of a thin film according to a first embodiment of the present invention. FIG. 2 is a schematic diagram showing an example of the construction of an evaluating apparatus 10 for evaluating the adhesion strength of a thin film according to embodiments of the present invention. FIG. 3 is a diagram useful in explaining an example of a process that detects whether detachment has occurred for a thin film 2. FIGS. 4A and 4B are diagrams useful in explaining a method of evaluating the adhesion strength of a thin film according to a second embodiment of the present invention, where FIG. 4A is a schematic diagram showing a state where a vibration transmitting member 6 has been interposed between the thin film 2 and an ultrasonic vibration needle 13 and FIG. 4B is an enlargement of a tip portion 13a of the ultrasonic vibration needle 13. FIG. 5 is a diagram useful in explaining a method of evaluating the adhesion strength of a thin film according to a third embodiment of the present invention. FIG. 6A is a schematic diagram showing a first specific example of evaluation thin films 3 and FIG. 6B is a schematic diagram showing a modification thereof. FIG. 7A is a schematic diagram showing a second specific example of an evaluation thin film 3 and FIG. 7B is a schematic diagram showing a modification thereof. FIG. 8 is a schematic diagram showing a third specific example of an evaluation thin film 3. FIG. 9 is a graph of experimental data showing examples of evaluation according to a method of evaluating the adhesion strength of a thin film according to embodiments of the present invention. FIG. 10 is a micrograph showing an example where detachment has occurred at an edge portion 2a of the thin film 2.

A variety of technologies have been disclosed as methods of evaluating the adhesion strength of films, such as the method of evaluating the adhesion strength of a film disclosed in Japanese Laid-Open Patent Publication No. H06-2135. However, such method of evaluating the adhesion strength is a technology for measuring hard films and detects whether detachment occurs by placing a vibrator in contact with the film.

On the other hand, when a patterned thin film is to be measured, even if such method is used to apply ultrasonic vibration to an inner portion of the pattern or to a thin film that has not been patterned, it will not be possible to correctly evaluate a patterned thin film. This is because for a soft metal thin film in particular, it is difficult for ultrasonic vibration applied to pattern inner portions to reach the pattern edges (i.e., edge portions of a thin film), and therefore the same action as for a hard film cannot be obtained.

The method of evaluating the adhesion strength of a thin film described below makes it possible to evaluate the adhesion strength of thin films that were difficult to evaluate using conventional methods, such as when the object to be measured is a thin film formed on a substrate.

The method of evaluating the adhesion strength of a thin film according to a first embodiment of the present invention will now be described with reference to FIG. 1. A pattern (metal thin film) formed on a substrate or the like during the manufacturing of a magnetic head, the manufacturing of a semiconductor, or the manufacturing of a printed circuit board can be given as examples of thin films formed on a substrate. Such thin film is composed of a comparatively soft metal material such as Au (gold) or Cu (copper) and is extremely thin at around several microns (μm) to several tens of microns in thickness perpendicular to the surface, and therefore is extremely soft (i.e., easily deformed) in spite of being a metal material.

Note that the thin film measured using the present method is not limited to a metal material or a conductive material.

The construction of an apparatus for realizing the method of evaluating according to the present embodiment is shown in FIG. 2.

In the evaluating apparatus 10 for evaluating the adhesion strength of a thin film, reference numeral 11 designates a stage onto which is fixed a measured object, that is, a sample 9 where the thin film 2 has been formed on an upper surface of a substrate 1. In the present embodiment, since it is necessary to position the sample 9, a stage that is movable in at least the XY directions is used (note that an ultrasonic vibration applying means 12 described later may be movable).

Reference numeral 12 designates an ultrasonic vibration applying means for applying ultrasonic vibration to the sample 9. Ultrasonic vibration generated by an ultrasonic vibrator 14 is applied to the sample 9 from the ultrasonic vibration needle 13. Note that a weight regulator 15 is provided to regulate the weight of the ultrasonic vibration needle 13.

Reference numeral 17 designates a means for measuring the electrical resistance of the thin film 2 and includes a resistance measuring unit 18 and a resistance measuring probe 19. In the present embodiment, the electrical resistance measuring means 17 is used as a detachment detecting means 16 for the thin film 2.

Reference numeral 20 is a means for obtaining an image of the thin film 2 and includes a microscope 21, an image pickup apparatus 22, and an image recognition unit 23. In the present embodiment, the recording image obtaining means 20 is used during positioning where the ultrasonic vibration needle 13 is placed in contact with a predetermined position (here, the edge portion) of the thin film 2. Note that it is also possible to use a construction where the image obtaining means 20 is also used as the detachment detecting means 16 for the thin film 2.

Note that it is possible for the evaluating apparatus 10 to be controlled using a control apparatus (not shown) composed of a personal computer or the like. In addition, by providing a detachment detection pattern on the thin film 2 (or the substrate 1) and providing a pattern recognition function and a resistance measurement function as part of the apparatus construction, it is possible to automate a series of evaluation steps that was difficult to achieve with the conventional art.

Next, the procedure of the method of evaluating according to the first embodiment will be described.

First, the sample 9 that is the measured object, that is, the substrate 1 on which the thin film 2 has been formed, is fixed on the stage 11 of the evaluating apparatus 10 described above. At this time, the image obtaining means 20 checks the position of the ultrasonic vibration needle 13 relative to the sample 9 and the stage 11 is moved to position the ultrasonic vibration needle 13 at a predetermined position on the sample 9.

Next, the ultrasonic vibration needle 13 is placed in contact with the edge portion 2a, i.e., a part located at an edge in the planar direction of the thin film 2, and ultrasonic vibration generated by the ultrasonic vibrator 14 is applied.

Here, the ultrasonic vibration is applied to the edge portion 2a because unlike a pattern inner portion 2c that is supported from the periphery thereof, the edge portion 2a is a part where it is easiest to evaluate the adhesion strength of the thin film 2. That is, by applying ultrasonic vibration to the edge portion 2a where there is little or no support from the periphery, it is possible to correctly evaluate the adhesion strength of a soft thin film.

For this reason, even if ultrasonic vibration is applied to a part 2b of the thin film 2 in the periphery of the edge portion 2a of the thin film 2 or a part 1a of the substrate 1 in the periphery of the edge portion 2a, it will still be possible to achieve the same action as when the ultrasonic vibration is directly applied to the edge portion 2a of the thin film 2.

The output level and application time for the ultrasonic waves applied to the thin film 2 via the ultrasonic vibration needle 13 are set as appropriate in predetermined ranges in accordance with the thickness and the like of the thin film 2. Note that although it is not necessary for the frequency of the ultrasonic waves to be variable, a suitable frequency is selected in accordance with the adhesion strength of the thin film to be evaluated. For example, ultrasonic waves with a frequency in a range of several tens of KHz to around 1 MHz are practical.

The tip of the ultrasonic vibration needle 13 is formed with a suitable size and form so as to be capable of contacting the edge portion 2a of the thin film 2, and may be spherical, wedge-shaped, cylindrical, or shaped like a square pillar. Here, it is preferable for minute concaves and convexes or mesh-like grooves to be provided in the form (i.e., the front tip surface) of the tip portion 13a so as to prevent point contact.

There are no particular limitations on the material of the ultrasonic vibration needle 13 so long as the ultrasonic vibration needle 13 can transmit the ultrasonic vibration and has a certain degree of strength. As examples, the ultrasonic vibration needle 13 can be favorably formed of a ceramic, W (tungsten), Ti (titanium), or the like. Note that the diameter of the ultrasonic vibration needle 13 is set as appropriate in accordance with the thickness and the like of the thin film 2, and as one example is around several tens to several hundred microns.

Next, after the ultrasonic vibration has been applied, occurrences of detachment of the film of the edge portion 2a of the thin film 2 are detected. The adhesion strength of the thin film 2 on the substrate 1 is evaluated from the extent to which detachment has occurred.

Qualitative evaluation of the adhesion strength is carried out by applying ultrasonic vibration according to predetermined conditions and judging whether detachment of the thin film has occurred at the part contacted by the ultrasonic vibration needle 13. Note that although the presence or absence of detachment is visually determined using the microscope 21, it is also possible to automate such determination by using a construction to which the image pickup apparatus (an image pickup camera) 22 and the image recognition unit 23 have been added.

On the other hand, quantitative analysis of the adhesion strength can be carried out by measuring how the rate with which detachment occurs depends on the output level of the ultrasonic waves, for example.

Also, as another method of measuring the extent to which detachment has occurred, when the thin film 2 to be evaluated is formed as wires with a predetermined width, it is possible to connect resistance measuring terminals 4 and 5 to both ends in the length direction of the thin film 2 (see FIG. 3), measure the electrical resistance of the thin film 2 before and after the step of applying ultrasonic vibration, and detect the extent of detachment by comparing the obtained resistance values. For example, when a change in resistance value occurs, it is determined that the state of the thin film 2 has changed, that is, that detachment has occurred.

Next, the procedure of a method of evaluating according to a second embodiment will be described.

The fundamental steps and construction of the evaluating apparatus are the same as in the first embodiment described above. The difference is in the step of applying ultrasonic vibration to the thin film 2 on the substrate 1 that is the measured object. In more detail, in the present embodiment, ultrasonic vibration is applied by interposing a vibration transmitting member 6 that is capable of line or surface contact on the edge portion 2a of the thin film 2 (or the peripheral portion 2b or 1a) between the edge portion 2a (or the peripheral portion 2b or 1a) and the ultrasonic vibration needle 13 (see FIG. 4A).

According to this method, when it is difficult for the ultrasonic vibration needle 13 to contact the edge portion 2a due to the thin film (for example, a wiring pattern) 2 to be measured being small or thin compared to the tip portion 13a of the ultrasonic vibration needle 13, for example, or when a thin film of a soft material is being tested, it is possible to apply ultrasonic vibration to the thin film 2 to be measured by interposing the vibration transmitting member 6 that is capable of line or surface contact.

Note that as one example, it is possible to use a thin wire-like member as the vibration transmitting member 6. In particular, ultrasonic vibration can be favorably applied to a thin film 2 composed of a soft material by interposing a soft and thin wire member (for example, a gold wire). Note that in the present embodiment, a groove is formed in the tip portion 13a of the ultrasonic vibration needle 13 to make it easy to hold a thin wire member.

Next, the procedure of a method of evaluating according to a third embodiment of the present invention will be described.

The fundamental steps and construction of the evaluating apparatus are the same as in the first and second embodiments described above. The difference with such embodiments is that when evaluating the adhesion strength of a thin film 2 that is the measured object and is to be used as a product, instead of detecting detachment by applying ultrasonic vibration directly to such thin film 2 itself, the method of evaluating the adhesion strength of a thin film according to the first embodiment or the second embodiment is carried out on an evaluation thin film 3 that is separately formed of the same material and the same thickness on the same substrate by the same forming step as the thin film 2 to evaluate the adhesion strength of the evaluation thin film 3. From such results, the adhesion strength is evaluated for the thin film 2 that is the object for which measurement is actually desired.

With the first embodiment and the second embodiment described above, depending on how the thin films 2 are to be used, in some cases it will be possible to carry out evaluation tests directly on thin films 2 that function as actual products and then still use the thin films 2 as actual products following the tests. However, according to this third embodiment, since evaluation tests are not carried out directly on the thin films 2 that will be used as products, there is no risk of detachment occurring for the thin films 2 used as products, and as a result, it will be possible to prevent defective products from appearing due to detachment even if such thin films 2 are used as products after the evaluation tests have been carried out.

This will now be described by way of specific examples.

First, a specific example of evaluation thin films 3 is shown in FIG. 5. A plurality of evaluation thin films 3 that are the same size or are smaller than the tip portion 13a of the ultrasonic vibration needle 13 are formed so as to be aligned in a rectangular pattern or a line pattern. An example of a rectangular pattern is shown in FIG. 6A and an example of a line pattern is shown in FIG. 6B.

By doing so, it is possible to reliably place the ultrasonic vibration needle 13 in contact with an edge portion 3a of an evaluation thin film 3. The thin film 2 used as products may be formed in the patterns described above.

Second specific examples of an evaluation thin film 3 are shown in FIGS. 7A and 7B. In the same way as the method shown in FIG. 3 described earlier, when a thin film (here, the evaluation thin film 3) is a conductor, detachment can be determined electrically. Here, by providing a detachment detection pattern in the form of a line with a narrow width, it is possible to detect detachment as changes in electrical resistance.

In particular, when the thickness of the thin film 2 is thin compared to the form of the tip portion 13a of the ultrasonic vibration needle 13 and it is difficult to apply ultrasonic vibration to a detachment detection pattern, it is possible to form a line pattern so as to double back on itself (see FIG. 7A) or in a spiral (see FIG. 7B). By doing so, the positioning margin of the ultrasonic vibration needle 13 with regard to the detachment detection pattern is improved. However, the spacing of the line pattern needs to be set so that shorting does not occur between lines due to deformation or the like during the application of ultrasonic vibration.

A third specific example of an evaluation thin film 3 is shown in FIG. 8. In this example, the evaluation thin film 3 is provided around the outer circumference of the thin film 2 used as a product. By using this arrangement, it is possible to refrain from providing the evaluation thin film 3 when such evaluation thin film 3 is problematic for a product, and to amend a patterning mask to form the evaluation thin film 3 and carry out evaluation only when such evaluation is actually necessary.

Note that although FIG. 8 shows an example where detachment is determined electrically in the same way as in FIG. 7, it is also possible to detect detachment visually or by carrying out image processing.

Note that as a modification to the first to third embodiments described above, it is possible to additionally perform a step of carrying out a process to accelerate the detachment, after the step of applying ultrasonic vibration and before the step of detecting the occurrence of detachment.

Examples of processes that accelerate detachment that are known from fields relating to semiconductor manufacturing include the following.
A process of immersing the object in a tank and applying ultrasonic waves or subjecting the object to a stream of water to which ultrasonic waves have been applied
A process that uses high-pressure water (such as processing with a high-pressure scrubber)
A process that uses a brush scrubber
A process that uses snow formed from liquid carbon dioxide (“Eco snow”)

By adding such step, it is possible to make parts of the thin film 2 where the adhesion strength is insufficient more prominent, and thereby facilitate the determination.

FIG. 9 shows the evaluation results (test data) for a thin film formed on a substrate as an example of evaluation carried out using a method of evaluating the adhesion strength of a thin film according to the above embodiments.

The thin film was made of Au and formed by vacuum deposition with a thickness of 1 μm on alumina via a 0.1 μm layer of Ti (an adhesion layer). The patterns were square with edges that are 60 μm long.

According to the method of evaluating according to the second embodiment described above, a thin wire member (Au wire) with a width of 30 μm was interposed as a vibration transmitting member between the thin film and the ultrasonic vibration needle, and ultrasonic vibration with a frequency of 63 kHz was applied for 30 msec to an edge portion of the thin film. For a test according to such conditions, FIG. 9 shows the results of measuring the occurrence rate of detachment of the thin film when an output condition (i.e., power) of the ultrasonic waves was changed. In this way, it is possible to quantitatively evaluate the adhesion strength of a thin film.

A micrograph for a case where detachment has occurred at the edge portion of the thin film is shown in FIG. 10. In FIG. 10, the part surrounded by the dotted line shows where detachment has occurred.

As described above, according to the method and apparatus for evaluating the adhesion strength of a thin film according to the present invention, it is possible to evaluate the adhesion strength of thin films formed in patterns that were difficult to evaluate with conventional techniques and it is possible not only to qualitatively evaluate a thin film but also quantitatively evaluate the dependency on the conditions of the ultrasonic waves.

What is claimed is:

1. A method of evaluating the adhesion strength of a thin film, comprising:
a step of placing an ultrasonic vibration needle in contact with one of an edge portion in a planar direction of a thin film formed on a substrate and a periphery of the edge portion, and applying ultrasonic vibration;
a step of detecting occurrences of detachment at the edge portion of the thin film after application of the ultrasonic vibration; and
a step of evaluating the adhesion strength of the thin film on the substrate according to the occurrences of detachment.

2. A method of evaluating the adhesion strength of a thin film according to claim 1,
wherein the step of applying the ultrasonic vibration interposes a vibration transmitting member, which is capable of line or surface contact on one of the edge portion of the thin film and the periphery thereof, between the one of the edge portion and the periphery thereof and the ultrasonic vibration needle.

3. A method of evaluating the adhesion strength of a thin film according to claim 1,
wherein the step of detecting the occurrences of detachment connects resistance measuring terminals to both ends in a length direction of the thin film that has been formed as wires of a predetermined width, measures an electrical resistance of the thin film before and after the step of applying the ultrasonic vibration, and detects the occurrences of detachment by comparing resistance values obtained before and after the step of applying the ultrasonic vibration.

4. A method of evaluating the adhesion strength of a thin film according to claim 2,
wherein the step of detecting the occurrences of detachment connects resistance measuring terminals to both ends in a length direction of the thin film that has been formed as a wire of a predetermined width, measures an electrical resistance of the thin film before and after the step of applying the ultrasonic vibration, and detects the occurrences of detachment by comparing resistance values obtained before and after the step of applying the ultrasonic vibration.

5. A method of evaluating the adhesion strength of a thin film according to claim 1,
wherein the thin film has a thickness of several microns to several tens of microns in a direction perpendicular to a surface thereof.

6. A method of evaluating the adhesion strength of a thin film according to claim 2,
wherein the thin film has a thickness of several microns to several tens of microns in a direction perpendicular to a surface thereof.

7. A method of evaluating the adhesion strength of a thin film according to claim 3,
wherein the thin film has a thickness of several microns to several tens of microns in a direction perpendicular to a surface thereof.

8. A method of evaluating the adhesion strength of a thin film according to claim 4,
wherein the thin film has a thickness of several microns to several tens of microns in a direction perpendicular to a surface thereof.

9. A method of evaluating the adhesion strength of a thin film according to claim 1,
further comprising, after the step of applying the ultrasonic vibration and before the step of detecting the occurrences of detachment, a step of carrying out a process to accelerate detachment.

10. A method of evaluating the adhesion strength of a thin film according to claim 2,
further comprising, after the step of applying the ultrasonic vibration and before the step of detecting the occurrences of detachment, a step of carrying out a process to accelerate detachment.

11. A method of evaluating the adhesion strength of a thin film according to claim 3,
further comprising, after the step of applying the ultrasonic vibration and before the step of detecting the occurrences of detachment, a step of carrying out a process to accelerate detachment.

12. A method of evaluating the adhesion strength of a thin film according to claim 4,
further comprising, after the step of applying the ultrasonic vibration and before the step of detecting the occurrences of detachment, a step of carrying out a process to accelerate detachment.

13. A method of evaluating the adhesion strength of a thin film according to claim 5,
further comprising, after the step of applying the ultrasonic vibration and before the step of detecting the occurrences of detachment, a step of carrying out a process to accelerate detachment.

14. A method of evaluating the adhesion strength of a thin film according to claim 6,
further comprising, after the step of applying the ultrasonic vibration and before the step of detecting the occurrences of detachment, a step of carrying out a process to accelerate detachment.

15. A method of evaluating the adhesion strength of a thin film according to claim 7,
further comprising, after the step of applying the ultrasonic vibration and before the step of detecting the occurrences of detachment, a step of carrying out a process to accelerate detachment.

16. A method of evaluating the adhesion strength of a thin film according to claim 8,
further comprising, after the step of applying the ultrasonic vibration and before the step of detecting the occurrences of detachment, a step of carrying out a process to accelerate detachment.

17. A method of evaluating the adhesion strength of a thin film,
wherein an evaluation thin film of a same material and a same thickness as a product thin film, which is formed on a substrate and is to be used as a product, is formed on the same substrate by a same step as the product thin film, and
the adhesion strength of the product thin film is evaluated by carrying out the method of evaluating the adhesion strength of a thin film according to claim 1 on the evaluation thin film.

18. A method of evaluating the adhesion strength of a thin film,
wherein an evaluation thin film of a same material and a same thickness as a product thin film, which is formed on a substrate and is to be used as a product, is formed on the same substrate by a same step as the product thin film, and
the adhesion strength of the product thin film is evaluated by carrying out the method of evaluating the adhesion strength of a thin film according to claim 2 on the evaluation thin film.

19. A method of evaluating the adhesion strength of a thin film,
wherein an evaluation thin film of a same material and a same thickness as a product thin film, which is formed on a substrate and is to be used as a product, is formed on the same substrate by a same step as the product thin film, and
the adhesion strength of the product thin film is evaluated by carrying out the method of evaluating the adhesion strength of a thin film according to claim 3 on the evaluation thin film.

20. An evaluating apparatus for evaluating the adhesion strength of a thin film, comprising:
a stage onto which is fixed a substrate that has a thin film formed on an upper surface thereof;
ultrasonic vibration applying means for applying ultrasonic vibration to one of an edge portion in a planar direction of the thin film and a periphery of the edge portion, the ultrasonic vibration applying means including an ultrasonic vibrator and an ultrasonic vibration needle; and
detachment detecting means for detecting occurrences of detachment at the edge portion of the thin film,
wherein the detachment detecting means includes at least one of means for obtaining an image of the edge portion of the thin film and means for measuring electrical resistance of the thin film.
